(19) United States
(12) Patent Application Publication
(10) Pub. No.: US 2003/0128826 A1
(43) Pub. Date: Jul. 10, 2003

(54) Charge metering system and method for data transmission, associated units, program and electronic credit

(76) Inventors: Giovanni Benini, Munchen (DE); Andreas Kalkbrenner, Munchen (DE); Andreas Mayerhofer, A-Wien (AT); Rainer Stademann, Egmating (DE); Rudolf Stelzl, Dachau (DE)

Correspondence Address: MORRISON & FOERSTER LLP, 1650 TYSONS BOULEVARD, SUITE 300, MCLEAN, VA, 22102, US

(21) Appl. No.: 10/038,857

(22) Filed: Jan. 8, 2002

(51) Int. Cl. H04M 15/00; H04M 11/00

(52) U.S. Cl. 379/114.01; 379/114.1; 379/91.01

(57) ABSTRACT

A method in which two terminals operated on a data transmission network store at least one electronic credit. With the aid of the credits, charge metering is performed. The electronic credits are transmitted with credit messages to control units, which check the validity of the credits and, depending on the result of the check, clear network resources.

### TECHNICAL FIELD OF THE INVENTION

The invention relates to a method of metering charges for data transmission, and in particular, to data transmission on at least two terminals operated on a data transmission network where a data transmission path is set up between the terminals.

### BACKGROUND OF THE INVENTION

In conventional telephone service, in which circuit-switched transmission networks are used, call control and allocation of network resources are controlled by exchanges, which in each case perform both control functions. As a result, the charge metering is comparatively simple to control.

Due to decoupling of call control and the allocation of network resources, the conventional control methods can only simulate with considerable expenditure. Therefore, a fundamentally different method is contemplated.

### SUMMARY OF THE INVENTION

In one embodiment of the invention, there is a method of metering charges for data transmission which, in particular, permits a large number of charge metering modes and, in particular, makes the unjustified use of transmission resources more difficult. Furthermore, a terminal suitable for carrying out the method, an associated control unit, program and electronic credit are to be provided.

In another embodiment of the invention, two terminals operate on a data transmission network and store at least one electronic credit. The credit includes a statement on the amount of use of transmission units of the data transmission network. Data transmission units of the network are controlled by two control units, located for example at the ends of a data transmission path. The terminals transmit a credit for use of the data transmission path to the control unit located on the respective side of the data transmission path. Depending on the credit received, the control unit clears the transmission units of the data transmission network to use the data transmission path. If the credit is valid, clearance takes place. If, on the other hand, the credit is invalid, the transmission units cannot be used for the transmission path.

An electronic credit authorizes use of the transmission units to a limited extent. No additional measures for clearing the transmission units have to be taken because, after the use fixed by the credit, the network resources can automatically be used for other purposes, unless a new credit arrives or has already arrived with the first credit. The electronic credits can be transmitted with previously used transmission protocols. For example, the credits are sent in electronic mail, known as e-mails.

The method of the invention contemplates the problem of controlling access to the transmission units of the data transmission network from two different control units, problems which do not occur when there is central control. In the case of decentralized controllers, call control is with the terminals, while the data transmission network is left to allocate the necessary resources, for example a specific transmission capacity with a specific transmission quality. Charge metering has to be carried out for the network resources. In the case of decentralized controllers, it is assumed that both the A side and the B side of a call have to request network resources from the network, for example bandwidths at the respective network access. The method also contemplates the situation where the clearance of network resources of both terminals is directly instigated by only one terminal require complex protocols. To avoid having to use such protocols, electronic credits are used in the method according to the invention.

In another embodiment of the invention, one terminal sends another terminal at least one electronic credit and can indirectly control the use of network resources by the other terminal. The credit coming from one terminal is sent by the terminal receiving the credit to the control unit which is located on the same side of the transmission path as the terminal concerned. In this regard, call metering methods in which the call metering component can be fixed within broad limits can be defined between the two terminals before the data transmission.

If the calling A side is to pay for the entire call, in a way corresponding to conventional charge metering in a fixed network, i.e. also in particular for the resources reserved by the B side, the following problem arises when setting up the call. The A side, as the paying subscriber, has an interest in clearing the resources involved in a call when the call is terminated, in order to stop the charge metering as well. For the B side, on the other hand, there is no reason to do this, since the B side is not paying for the resources. The correct charge metering for the network resources would consequently no longer be ensured. Here it is likewise assumed that the resource can in each case be cleared only by the side requesting it. Similar considerations also apply if the B side is the paying side and the use of network resources by the A side is to be paid by the B side.

In a refinement, the terminal beginning the data transmission, i.e. the A side, therefore sends the credit or the credits. In this refinement, the classic metering method, in which the call is only paid for by the caller, is used. The same considerations also apply, however, to a data transmission of computer data outside a conversation. The problem mentioned above can be solved in by the use of credits, which permit the use of network resources to a restricted extent. In an alternative embodiment, the credit is sent by the terminal responding to a network-side request for data transmission, i.e. the terminal of the B side. Such charge metering is used when offering services which are free of charge for the caller.

Alternatively, the A side sends the B side every second credit which the B side uses. The credits required in the interim are obtained by the B side from somewhere other than from the terminal of the A side.

In another embodiment of the invention, the electronic credits are issued in conjunction with the data transmission path which is to be set up or has already been set up. Misuse of the credits is made even more difficult by this measure. In a refinement, the electronic credit includes statements which identify the data transmission path:

an identification of the terminal beginning the data transmission,

an identification of the other terminal,

an identification for the interface used in the data transmission of the terminal beginning the data transmission, for example a port number,

an identification for the interface used in the data transmission of the other terminal, and/or

an identification for a transmission protocol used in the data transmission.

The statements included in the electronic credit are checked by the control units. The credit can be used for the transmission path which is specified by the statements. The statements mentioned have the effect in particular of making it even more difficult for the credits to be used twice or more.

In another embodiment of the invention, a period of validity or a date of validity is fixed for the credits. For example, the credits include a date and/or a time of day, the value of which indicates a point in time at which the credit loses its validity. As a reference point for this time, Central European Time or a time fixed for use of the Internet may be chosen for example. The period of validity is fixed on the basis of a call metering unit. For example, the call metering time five minutes after the credit is issued is chosen. In the case of other credits, a period of validity of one minute or less than one minute is chosen, for example 30 seconds. In particular in the case of credits which both include the statements relating to the transmission path and are restricted in their period of validity, a high level of security in the use of the credits is achieved.

In another embodiment of the invention, the statements included in the credits are protected with the aid of a cryptographic method. The control units check the genuineness of the credits with the aid of the cryptographic methods. Such cryptographic methods are included for example in the standard X.509 laid down by the ITU-T (International Telecommunication Union—Telecommunication Sector). Consequently, certification chains are used when issuing the credits. With the aid of the cryptographic methods it can be ensured that the credit is actually issued by an authorized agency. Additionally, it can be checked in a whether the credit has been changed. One frequently used method is the DES algorithm (Data Encryption Standard) or the RAS algorithm (Rivest, Shamir, Adleman). It can be ensured by an electronic signature that misuse of the credits is restricted.

The data transmission network is, for example, a packet-switched network operating according to the Internet Protocol, for example the Internet. However, the method is also used in other data transmission networks, for example in ATM networks (Asynchronous Transfer Mode) The method according to the invention or its various embodiments can also be used, however, in classic circuit-switched networks.

For setting up and clearing down the data transmission path on a higher protocol layer, preferably the protocol SIP (Session Initiation Protocol) is used, laid down by the IETF (Internet Engineering Task Force) in the RFC2543 (Request for Comment). Alternatively, a protocol of the H.323 protocol family is used for connection control. These protocols have been laid down by the ITU-T. In particular, the protocols H.225 and H.245 belong to this protocol family. However, other suitable protocols are also used.

For allocating the network resources, the protocol RSVP (Resource Reservation Protocol) is used, laid down by the IETF in RFC2205. Alternatively, a different protocol or method of allocating network resources may also be used, however. For instance, the protocol DiffServ (Differentiated Service) is used, see RFC244.

The method according to the invention and the various embodiments are used in particular for the transmission of voice data in real time. Real time means that, after they have been generated, the voice data have to be transmitted within less than 250 ms, for example, from one terminal to the other terminal. In voice services, it is particularly important for the acceptance of these services that different methods of charging are used. What is more, specifically in the case of the transmission of voice data, attention must be paid to the prevention of misuse.

The invention also relates to a terminal and a control unit which are constructed in such a way that the method according to the invention or one of its embodiments is performed during their operation. Furthermore, the invention relates to a program which is required for performing the method according to the invention and the various embodiments. The technical effects mentioned above apply to the terminal, the control unit and the program.

The invention also relates to an electronic credit which is suitable for use in the method according to the invention or in one of its developments. The credit includes statements which fix the amount of use of transmission units of the data transmission network. If appropriate, the credit includes statements concerning the transmission path and statements concerning validity. The use of cryptographic signature and/or encryption methods allows the possibility of misuse of the credit to be restricted. For example, the credit is formed by digital data of a data record which are structured in accordance with predetermined data fields.

### BRIEF DESCRIPTION OF THE DRAWINGS

Exemplary embodiments of the method according to the invention are explained below with reference to the drawings.

FIGS. 1A and 1B show signaling messages exchanged when setting up a connection between two terminals.

### DETAILED DESCRIPTION OF THE PREFERRED EMBODIMENTS

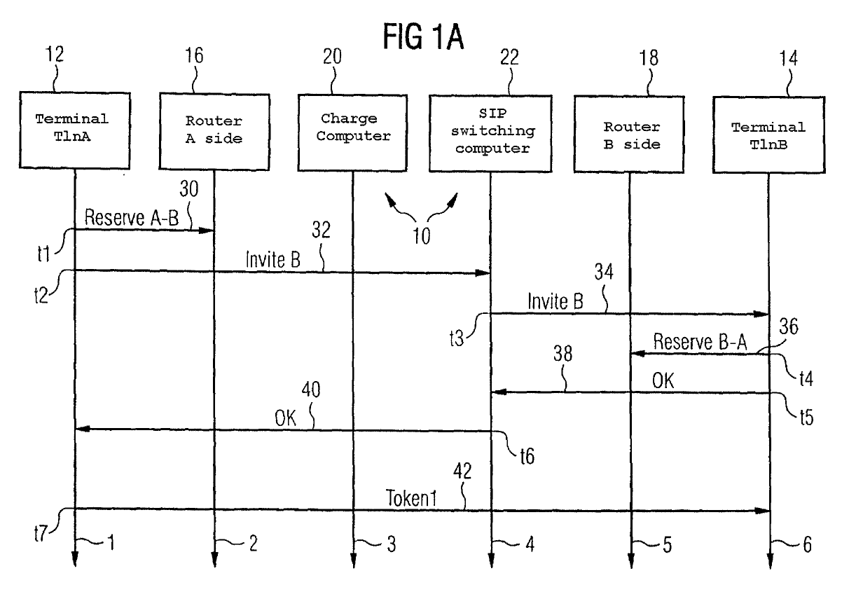

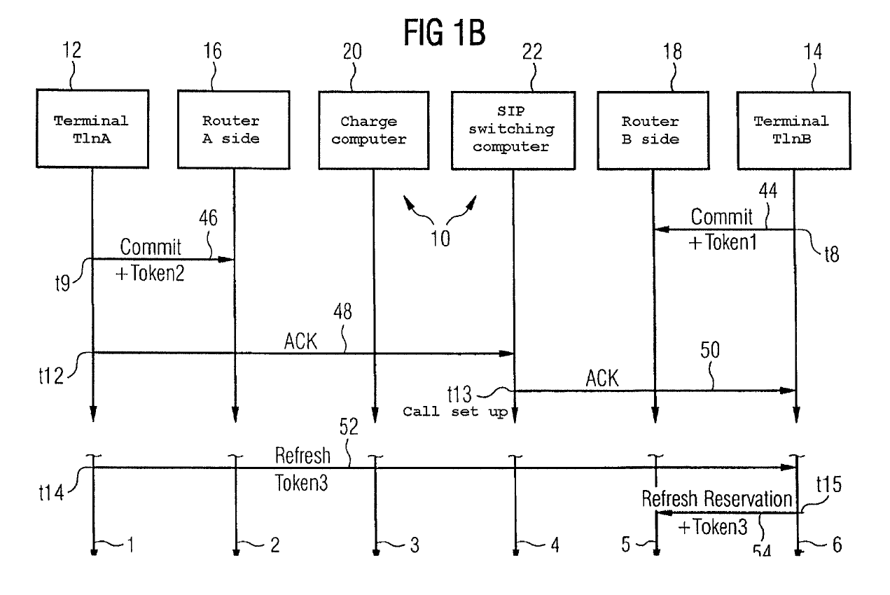

FIGS. 1A and 1B show component parts of a data transmission network 10. With the aid of two terminals 12 and 14, data can be sent and received via the data transmission network 10. The data of the terminal 12 are transferred into the data transmission network 10 via a transfer unit 16 (router). In this case, the transfer unit 16 is the first transfer unit for data which come from the terminal 12 and the last transfer unit for data which are transmitted to the terminal 12. On the side of the terminal 14 there is a transfer unit 18, which has the same function in relation to the terminal 14 as the transfer unit 16 has in relation to the terminal 12.

In the data transmission network 10 there is also a charge computer 20 (Record Keeping System) and a switching computer 22 (SIP Proxy). In a first exemplary embodiment, the electronic credits are issued in the charge computer. Depending on the credits requested, an account for the subscriber requesting the credits is debited. The switching computer 22 operates in accordance with the SIP protocol (Session Initiation Protocol).

Signaling messages which are generated when setting up a call connection between the terminal 12 and the terminal 14 are explained below. Time lines 1 to 6 are assigned in this sequence to the units 12, 16, 20, 22, 18 and 14. It is assumed for purposes of this example that the terminal 12 is the calling terminal and the subscriber using this terminal 12 is consequently the calling subscriber TlnA. The terminal 14 is the called terminal, so that the subscriber using the terminal 14 is a called subscriber TlnB. When explaining the signaling messages, confirmation messages provided in the protocols used are explained below only as the exception. As far as these confirmation messages are concerned, you are referred to the protocols mentioned.

At a point in time t1, the terminal 12 sends a reservation message 30 according to protocol RSVP to the transfer unit 16, to reserve a predetermined transmission bandwidth and consequently transmission units or parts of transmission units of the data transmission network 10 for the transmission path to be set up to the terminal 14. Subsequently, at a point in time t2, a message 32 is sent from the terminal 12 to the switching computer 22 in order to set up a voice transmission connection to the terminal 14. The message 32 is also referred to according to the SIP protocol as an invite message. The switching computer 22 determines according to the destination stated in the message 32 the Internet address of the terminal 14 and, for its part, sends a message 34 to the terminal 14 at a point in time t3. The message 34 is referred to according to the SIP protocol as an invite message. Once the message 34 has been received, the terminal 14 sends a reservation message 36 in accordance with the RSVP protocol to the transfer unit 18 at a point in time t4. With the aid of the reservation message 36, a specific bandwidth is reserved between the terminal 14 and the transfer unit 18 for the connection to be set up between the terminal 14 and the terminal 12.

At a point in time t5, the terminal 14 sends a confirmation message 38 to the switching computer 22 in accordance with the SIP protocol. The confirmation message 38 also inclues a port number to be used for the transmission path to be set up. After receiving the confirmation message 38, the switching computer 22 transfers the determined Internet address and the port number to the terminal 12 at a point in time t6 in a confirmation message 40. The confirmation message 40 is likewise transmitted in accordance with the SIP protocol.

Electronic credits which permit the use of network resources in the data transmission network 10 are stored in a memory unit of the terminal 12. These electronic credits were requested from the charge computer 20 shortly before the point in time t1. For the credits stored in the terminal 12, an account set up for the subscriber TlnA was exclusively debited.

At the point in time t7, the terminal 12 sends a credit to the terminal 14, using the Internet address and port number received in the message 40. For transmitting the credit, a credit message 42 is used. The protocol SIP was extended by such a message for the method according to the invention to be carried out.

The terminal 14 receives the electronic credit transmitted by the terminal 12 and sends this credit to the transfer unit 18 at a point in time t8 with the aid of a clearing message 44. The clearing message 44 serves for clearing the bandwidth reserved with the aid of the reservation message 36. According to an extension of the standard RSVP, the clearing message 44 is also referred to as a commit message. The clearing message 44 contains a data field with the aid of which the electronic credit coming from the terminal 12 can be transmitted to the transfer unit 18.

After receiving the clearing message 44, the transfer unit 18 checks whether the credit received is valid. For this purpose, statements included in the credit concerning the period of validity are used. Since the credit in the exemplary embodiment is valid, the reserved resources are cleared and can be used for the voice transmission between the terminal 12 and the terminal 14, or in the opposite direction.

At a point in time t9, the terminal 12 sends a clearing message 46 to the transfer unit 16, to clear the network resources requested with the aid of the reservation message 30. According to the extended RSVP protocol, the clearing message 46 is also referred to as a commit message. The clearing message 46 also includes a data field for the transmission of a credit. In this data field, the terminal 12 transmits a second credit. After receiving the clearing message 46, the transfer unit 16 checks whether the second credit is still valid. Let us assume that this is the case. Therefore, the reserved resources are cleared.

At a point in time t12, the terminal 12 sends a confirmation message 48 in accordance with the SIP protocol, in order to acknowledge the reception of the confirmation message 40. The confirmation message 48 passes to the switching computer 22 and, at a point in time t13, is transferred from there to the terminal 14 as confirmation message 50. According to the SIP protocol, a connection is then set up on a higher protocol layer by means of the cleared network resources.

Voice data are repeatedly exchanged between the terminals 12 and 14. The transfer units 16 and 18 check whether the credits transmitted to them are still valid. Should it be found that the period of validity of a credit has expired, the transfer unit 16 or 18 concerned would use the resources used for the transmission path between the terminal 12 and the terminal 14 for other purposes. To prevent this, a refresh message 52 is transmitted by the terminal 12 to the terminal 14 before the expiry of the credits. The SIP protocol has been extended by the refresh message 52. In the refresh message 52, the terminal 12 transmits a third credit, which has been requested from the charge computer 20 by the terminal 12 in the meantime, for example a few seconds before the expiry of the first credit and the second credit. The terminal 14 receives the third credit and, for its part, sends a refresh message 54 with the third credit to the transfer unit 18 at a point in time t15. The transfer unit 18 checks the third credit and assigns the credit to the transmission path existing connection between the terminal 12 and the terminal 14. Since the third credit has arrived before the expiry of the first credit, the reserved and cleared network transmission units remain available for the transmission path.

Before expiration of the second credit, the terminal 12 sends to the transfer unit 16 a fourth credit, requested in the meantime from the charge computer 20.

In another exemplary embodiment, the terminal 12 requests the electronic credits from the charge computer 20 after it knows the connection parameters for the transmission path. These parameters are transmitted to the charge computer 20. When the credits are issued, the transmitted statements are taken into consideration and encrypted in the electronic credit. The transfer units 16 check whether the credits are assigned to the connection set up between the terminal 12 and the terminal 14. Credits which are assigned to this connection are accepted. Otherwise, the method steps remain unchanged. In particular, the period of validity is also checked.

What is claimed is:

1. A charge metering method for data transmission, comprising:
storing at least one electronic credit which includes a statement on the amount of use of transmission units of a data transmission network on two terminals operated on the data transmission network;
controlling the use of data transmission units of the data transmission network by two control units;
transmitting a credit for use of the data transmission path to an assigned control unit; and
clearing the transmission units of the data transmission network to use the data transmission path based on the credit received.

2. The method as claimed in claim 1, wherein one of the terminals sends the other terminal the at least one electronic credit, and the credit coming from the one terminal is sent by the other terminal to the assigned control unit.

3. The method as claimed in claim 2, wherein the terminal sending the credit is the terminal beginning the data transmission or the terminal responding to a network-side request for data transmission.

4. The method as claimed in claim 1, wherein the at least one electronic credit is issued in conjunction with the data transmission path which is to be set up or has been set up.

5. The method as claimed in claim 1, wherein the at least one electronic credit includes at least a statement of the data transmission path including at least one of an identification of the terminal beginning the data transmission, an identification of the other terminal, an identification for the interface used in the data transmission of the terminal beginning the data transmission, an identification for the interface used in the data transmission of the other terminal and an identification for a transmission protocol used in the data transmission, wherein the statement is checked by the control units.

6. The method as claimed in claim 1, wherein a period of validity or a date of validity is electronically fixed for the at least one electronic credit, and the period of validity is at least one of less than approximately five minutes, less than approximately one minute or less than approximately 30 seconds from the issue of the electronic credit, and the period of validity and/or the date of validity are checked by the control units.

7. The method as claimed in claim 5, wherein the statement included in the at least one electronic credit is protected with the aid of a cryptographic method, and the control units check the genuineness of the at least one electronic credit.

8. The method as claimed in claim 6, wherein the statement included in the credits is protected with the aid of a cryptographic method, and the control units check the genuineness of the electronic credits.

9. The method as claimed in claim 1, wherein the data transmission network is a data transmission network operating in accordance with Internet Protocol, and/or for setting up the data transmission path the protocol SIP is used, and/or for allocating the network resources of the data transmission network the protocol RSVP or a protocol for the method DiffServ is used.

10. The method as claimed in claim 1, wherein the method is used for the transmission of voice data as part of a telephone service.

11. A system, comprising:
two terminals operated on a data transmission network storing at least one electronic credit which includes a statement on the amount of use of transmission units of the data transmission network; and
two control units in which the use of data transmission units of the data transmission network is controlled, wherein
the terminals transmit a credit for use of the data transmission path to an assigned control unit, and depending on the credit received, the control units clear the transmission units of the data transmission network to use the data transmission path.

12. A computer readable medium having a program with a series of commands, a processor executing the program to perform:
storing at least one electronic credit which includes a statement on the amount of use of transmission units of a data transmission network on two terminals operated on the data transmission network;
controlling the use of data transmission units of the data transmission network by two control units;
transmitting a credit for use of the data transmission path to an assigned control unit; and
clearing the transmission units of the data transmission network to use the data transmission path based on the credit received.

13. A control unit in which data transmission units of a data transmission network is controlled, wherein a terminal transmits a credit for use of the data transmission path to the assigned control unit, and depending on the credit received, the control unit clears the transmission units of the data transmission network to use the data transmission path.

14. A terminal operated on a data transmission network storing at least one electronic credit which includes a statement on the amount of use of transmission units of the data transmission network, wherein
the terminal transmits a credit for use of the data transmission path to an assigned control unit, and depending on the credit received, the control unit clears the transmission units of the data transmission network to use the data transmission path
